(19) United States
(12) Patent Application Publication
(10) Pub. No.: US 2013/0116029 A1
(43) Pub. Date: May 9, 2013

(54) GAMING CONTROLLER, DEVICE AND METHOD OF GAMING

(71) Applicant: Aristocrat Technologies Australia Pty Limited, North Ryde (AU)

(72) Inventor: Matthew Chan, East Killara (AU)

(73) Assignee: Aristocrat Technologies Australia Pty Limited, North Ryde (AU)

(21) Appl. No.: 13/724,217

(22) Filed: Dec. 21, 2012

Related U.S. Application Data
(63) Continuation of application No. 12/728,766, filed on Mar. 22, 2010, now abandoned.

(30) Foreign Application Priority Data
Mar. 20, 2009 (AU) 2009901229

(51) Int. Cl. G07F 17/32

(52) U.S. Cl. CPC G07F 17/3258
USPC 463/16; 463/26

(57) ABSTRACT

A method of awarding a jackpot, the method including determining whether a jackpot trigger, which is configured to occur based on a monetary turnover value associated with a gaming device, has occurred within a predefined period of time; and causing the jackpot trigger to occur irrespective of the monetary turnover value associated with the gaming machine if it is determined that the jackpot trigger has not occurred within the predefined period of time.

### CROSS-REFERENCE TO RELATED APPLICATIONS

The present application relates to and claims the benefit of priority from U.S. patent application Ser. No. 12/728,766, filed on Mar. 22, 2010, and Australian Provisional Patent Application Number 2009901229, filed on Mar. 20, 2009, which are herein incorporated by reference in their entireties.

### FIELD

The present invention relates to a gaming controller, a gaming device and method of gaming.

### BACKGROUND

Many venues employ controllers for awarding prizes to one or more of a plurality of gaming devices participating in a linked event. For example, in a linked event where jackpot prizes are awarded, a portion of turnover on each gaming device will typically be forwarded to a jackpot controller as a contribution. That is, part of each wager goes towards the jackpot. The technique can be extended to a so called wide area jackpot where gaming devices from a number of different venues contribute to a single jackpot pool.

While such techniques provide an opportunity for players to win large jackpot prizes, the need exists for alternative gaming systems in order to maintain or increase player enjoyment.

### SUMMARY

In a first aspect there is provided a method of awarding a jackpot, the method including:

determining whether a jackpot trigger, which is configured to occur based on a monetary turnover value associated with a gaming device, has occurred within a predefined period of time; and

causing the jackpot trigger to occur irrespective of the monetary turnover value associated with the gaming device if it is determined that the jackpot trigger has not occurred within the predefined period of time.

In an embodiment, the method further includes initiating a jackpot event in response to the jackpot trigger occurring. A prize may be awarded in the jackpot event in response to an award criterion being met. It will be understood that the term “jackpot event” is used herein to describe any form of special event and should not be seen as being limited only to events where a jackpot prize is awarded from a jackpot prize pool. For example, a jackpot event may include initiating a linked game or bonus round whereby players compete for the opportunity to win some form of prize or award.

In an embodiment the method further includes varying the predefined time period for subsequent triggers.

In an embodiment the amount by which the predefined time is varied is not advertised to players of the gaming device.

In an embodiment the predefined time period is varied dependent, at least in part, on whether a current time period is a peak or non-peak time period.

In an embodiment the method further includes making a determination as to whether the current period is a peak or non-peak time period based on a jackpot contribution rate for gaming devices participating in the jackpot.

In an embodiment a probability of the jackpot trigger occurring before the predefined time period has elapsed is dependent on either an amount or rate of contributions made by one or more of the gaming devices toward a prize pool from which a jackpot prize is awarded.

In an embodiment the method further includes allocating tickets to the participating gaming devices in accordance with an allocation criteria, such that for each of the participating game devices a probability of being awarded the prize is dependent on the number of tickets allocated thereto.

In an embodiment the probability is further dependent on a total number of tickets allocated.

In an embodiment the allocation criteria specifies a number or rate of tickets to allocate to individual gaming devices of the participating gaming devices, based on contributions made towards the jackpot prize pool. In an alternative embodiment the tickets are allocated to the participating gaming devices in a random fashion.

In an embodiment the jackpot is triggered when a predefined total number of tickets have been allocated. In another embodiment, the jackpot is ordinarily triggered when a predefined jackpot prize pool amount has been reached.

In an embodiment a probability of an individual participating gaming device being awarded a prize in the jackpot event is dependent on the number of tickets allocated to that gaming device.

According to a second aspect of the present invention there is provided a controller for a gaming system, the controller including:

a configuration module operable to determine whether a jackpot trigger, which is configured to occur based on a monetary turnover value associated with a gaming device, has occurred within a predefined period of time; and

a trigger module arranged to cause the jackpot trigger to occur irrespective of the monetary turnover value associated with the gaming device if it is determined that the jackpot trigger has not occurred within the predefined period of time.

In an embodiment, the trigger module is further configured to initiate a jackpot event in response to the jackpot trigger occurring. The controller may further include an award module arranged to award a prize in response to an award criterion being met in the jackpot event.

In an embodiment the predefined time period varies for subsequent jackpot events.

In an embodiment the predefined time period varies dependent, at least in part, on whether a current time period is a peak or non-peak time period.

In an embodiment a determination is made by the controller as to whether the current period is a peak or non-peak time period based on a jackpot contribution rate for gaming devices participating in the jackpot.

In an embodiment a probability of the jackpot trigger occurring before the predefined time period has elapsed is dependent either an amount or rate of contributions made by one or more of the gaming devices toward a prize pool from which a jackpot prize is awarded.

In an embodiment the system further includes a ticket allocating module arranged to allocate tickets to the participating gaming devices in accordance with an allocation criteria, such that for each participating gaming device a probability of being awarded the prize is dependent on the number of tickets allocated thereto.

In an embodiment the probability is further dependent on a total number of tickets allocated by the ticker allocating module.

In an embodiment the ticket allocating module is arranged to process contributions made by participating gaming devices toward the jackpot prize pool and allocate tickets to the gaming devices based on their individual contributions.

In an embodiment the trigger module is arranged to trigger the next jackpot event when a predefined number of tickets have been allocated to participating gaming devices.

In an embodiment the jackpot event is triggered when a predefined prize pool amount has been reached.

In accordance with a third aspect the present invention provides a gaming system including:

at least one gaming device arranged to participate in a jackpot event; and

a controller according to the second aspect, arranged to trigger a jackpot event in which a prize is eligible to be awarded.

In an embodiment the controller is implemented by one or more of the at least one gaming devices.

In accordance with a fourth aspect the present invention provides a gaming device operable to communicate with other gaming devices over a communications network, the gaming device including:

a configuration module operable to determine whether a jackpot trigger, which is configured to occur based on a monetary turnover value associated with a gaming device, has occurred within a predefined period of time; and

a trigger module arranged to cause the jackpot trigger to occur irrespective of the monetary turnover value associated with the gaming device if it is determined that the jackpot trigger has not occurred within the predefined period of time.

In accordance with a fifth aspect the present invention provides a computer program code which when executed by a computing system implements the method according to the first aspect.

In accordance with a sixth aspect the present invention provides a computer readable medium including the computer program code according to the fifth aspect.

In accordance with a seventh aspect the present invention provides a data signal including the computer program code according to the fifth aspect.

In accordance with an eighth aspect the present invention provides a method including transmitting or receiving the computer program code according to the fifth aspect.

In accordance with a ninth aspect of the present invention there is provided a method of awarding a jackpot, the method including:

responsive to determining that a jackpot event has not been triggered within a predefined time period of a last jackpot event being triggered, triggering a next jackpot event; and

awarding a prize responsive to an award criterion being met in the next jackpot event.

### BRIEF DESCRIPTION OF THE DRAWINGS

Features and advantages of the present invention will become apparent from the following description of embodiments thereof, by way of example only, with reference to the accompanying drawings, in which:

FIG. 1 is a block diagram of a gaming system;

FIG. 2 is a perspective view of a gaming device in the form of a stand alone gaming machine;

FIG. 3 is a block diagram of the functional components of the gaming machine of FIG. 2;

FIG. 4 is a block diagram representing the structure of a memory;

FIG. 5 is a diagram showing a system configuration in accordance with an alternative embodiment;

FIG. 6 is a block diagram of a jackpot controller;

FIG. 7 is a flow diagram of an embodiment; and

FIG. 8 is a flow diagram of yet a further embodiment.

### DETAILED DESCRIPTION

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, etc. storing the software and/or firmware.

Referring to the drawings there is shown a jackpot controller 111 including a configuration module 623 operable to determine whether a jackpot trigger, which is configured to occur based on a monetary turnover value associated with a gaming device, has occurred within a predefined period of time. A trigger module 622 implemented by the jackpot controller 111 is arranged to cause the jackpot trigger to occur irrespective of the monetary turnover value associated with the gaming device if it is determined that the jackpot trigger has not occurred within the predefined period of time. In response to determining the jackpot trigger, the trigger module 622 may initiate a jackpot event in which a jackpot prize is eligible to be awarded.

### General System Configuration

In the gaming system configuration 100A, a jackpot controller 110 is in data communication with a plurality of gaming devices 120 over a network 130. The jackpot controller 110 is operable to trigger and co-ordinate play of jackpot events during which players of the gaming devices 120 are provided with an opportunity to win jackpot prizes. In the embodiment described herein, it will be understood that a jackpot event could simply be the instantaneous awarding of a jackpot prize, or alternatively could be the triggering of a game (e.g. a bonus or co-operative game, etc.) in which the jackpot prize is eligible to be awarded.

### Gaming Devices

Within the detailed description, the term gaming device is used to refer to any device used by a player to a play a game of chance and specifically includes stand alone gaming machines and interactive video terminals which implement games in a client/server architecture.

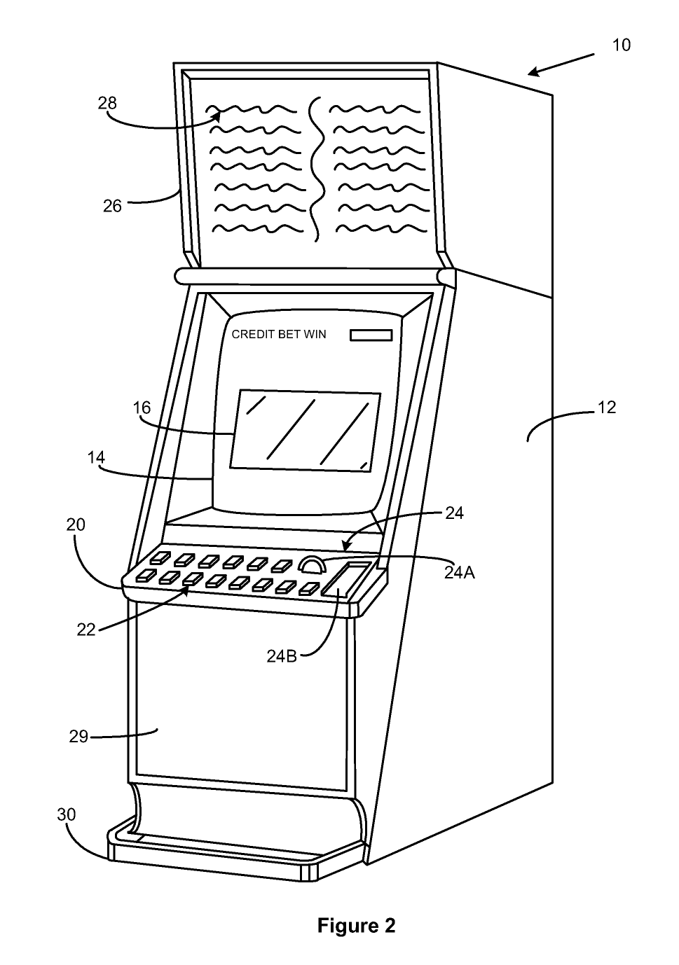

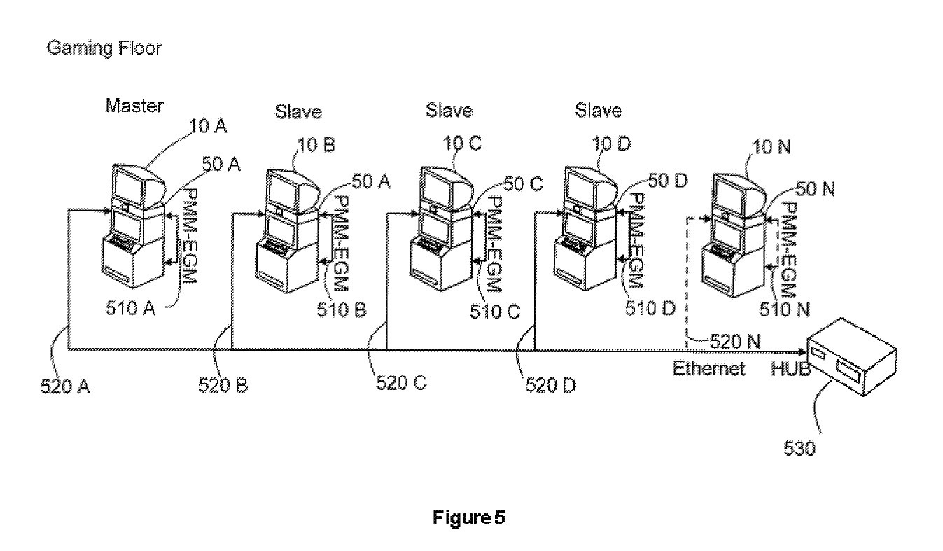

A gaming device in the form of a stand alone gaming machine 10 is illustrated in FIG. 2. The gaming machine 10 includes a cabinet 12 having a display 14 on which is displayed representations of a game 16 that can be played by a player. A mid-trim 20 of the gaming machine 10 houses a bank of buttons 22 for enabling a player to interact with the gaming machine 10, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module 50 (see FIG. 5) including a reading device may also be provided for the purpose of reading a player tracking device, for example as part of a loyalty program. The player tracking device may be in the form of a card, flash drive or any other portable storage medium capable of being read by the reading device.

A top box 26 may carry static artwork 28, including for example pay tables and details of bonus awards and other information or images relating to the game 16. Further artwork and/or information may be provided on a front panel 29 of the cabinet 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

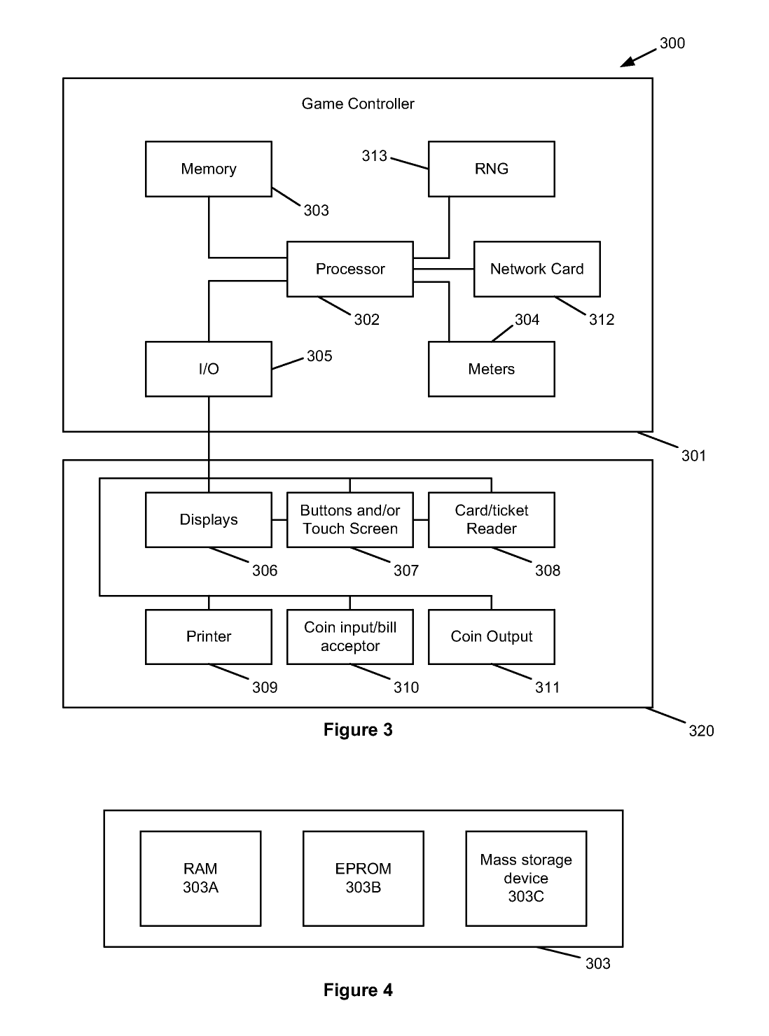

FIG. 3 shows a block diagram of operative components of a typical gaming machine 300 which may be the same as or different to the gaming machine of FIG. 2.

The gaming machine 300 includes a game controller 301 having a processor 302. Instructions and data to control operation of the processor 302 are stored in a memory 303, which is in data communication with the processor 302. Typically, the gaming machine 300 will include both volatile and non-volatile memory and more than one of each type of memory, with such memories being collectively represented by the memory 303.

The gaming machine 300 has hardware meters 304 for purposes including ensuring regulatory compliance and monitoring player credit, an input/output (I/O) interface 305 for communicating with peripheral devices of the gaming machine 300. The input/output interface 305 and/or the peripheral devices may be intelligent devices with their own memory for storing associated instructions and data for use with the input/output interface or the peripheral devices. A random number generator module 313 generates random numbers for use by the processor 302. Persons skilled in the art will appreciate that the reference to random numbers includes pseudo-random numbers.

In the example shown in FIG. 3, a player interface 320 includes peripheral devices that communicate with the game controller 301 include one or more displays 306, buttons and/or a touch screen 307, a card and/or ticket reader 308, a printer 309, a bill acceptor and/or coin input mechanism 310 and a coin output mechanism 311. Additional hardware may be included as part of the gaming machine 300, or hardware may be omitted based on the specific implementation.

In addition, the gaming machine 300 may include a communications interface, for example a network card 312. The network card 312 may, for example, send status information, accounting information or other information to a central controller, server or database and receive data or commands from the central controller, server or database.

FIG. 4 shows a block diagram of the main components of an exemplary memory 303. The memory 303 includes RAM 303A, EPROM 303B and a mass storage device 303C. The RAM 303A typically temporarily holds program files for execution by the processor 302 and related data. The EPROM 303B may be a boot ROM device and/or may contain some system or game related code. The mass storage device 303C is typically used to store game programs, the integrity of which may be verified and/or authenticated by the processor 302 using protected code from the EPROM 303B or elsewhere.

It is also possible for the operative components of the gaming machine 300 to be distributed, for example input/output devices 306,307,308,309,310,311 to be provided remotely from the game controller 301.

A gaming machine as indicated above may also take the form of a client/server architecture where a portion of the game is executed on the client and a portion of the game is executed on the server. In such embodiments, the client typically takes the form of an interactive video terminal which has a similar outward appearance to the gaming machine described above. A person skilled in the art will appreciate that the type of gaming machine that is employed is not important to the present invention.

A further possible gaming system configuration is shown in FIG. 5. From FIG. 5 it is seen that a plurality of gaming machines 10 each implement a player marketing module PMM 50 which is connected to the electronic gaming machine via a serial connection 510. Each PMM 50 is additionally connected by an Ethernet connection 520 to an Ethernet hub 530.

Utilising the PMMs 50, it is possible for the gaming machines 10 to communicate with one another over the Ethernet 520. In the embodiment, an Ethernet compatible protocol allows broadcast communications (e.g. to a broadcast address) as well as address communications to be made between one of the gaming machines and another of the gaming machines.

Thus, according to the FIG. 5 configuration, one of the gaming machines 10 is a capable of acting as a server providing networked game play and/or jackpot functionality. In the specific embodiment illustrated in FIG. 5, gaming machine 10a is designated as a master (i.e. the server) whereas the remaining gaming machines 10b to 10n are designated as slaves (i.e. the clients).

### Further Detail of the Controller

As described in preceding paragraphs, embodiments of the present invention relate to a system, controller and method for triggering jackpots. More specifically, embodiments relate to a system for forcibly triggering a jackpot when the jackpot has not ordinarily been triggered within a predefined time period.

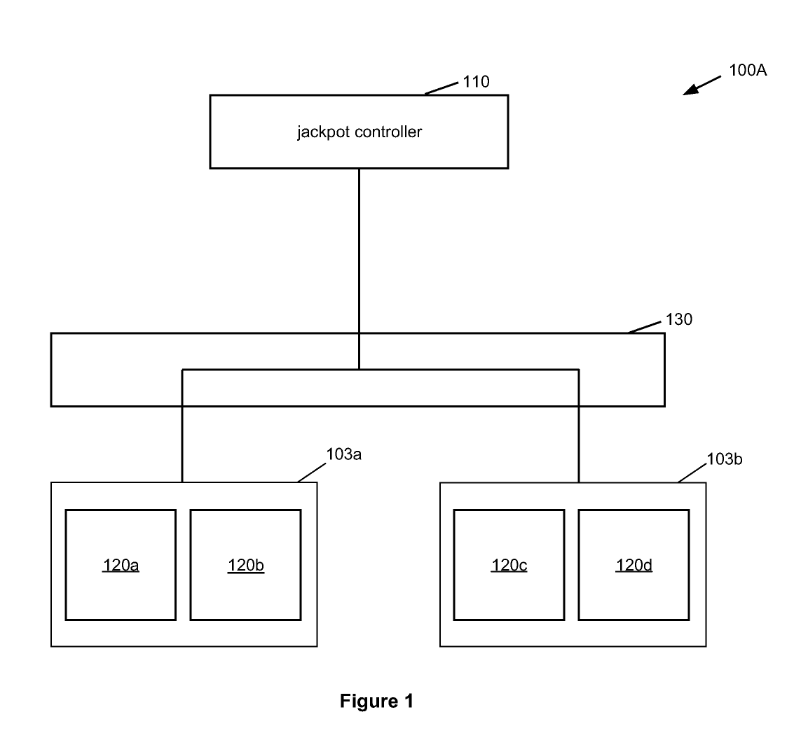

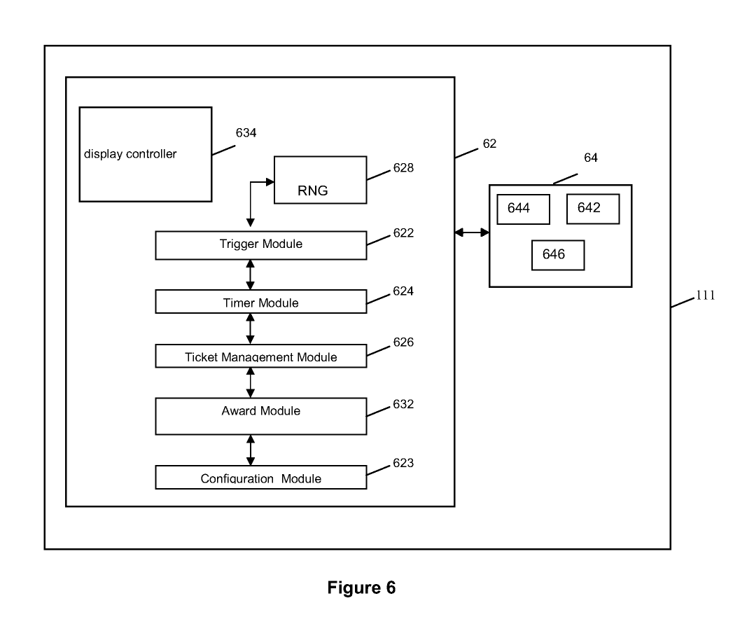

To carry out such functionality, the gaming system includes a controller 111, as shown in more detail in FIG. 6. According to the described embodiment, the controller 111 is incorporated into the jackpot controller 110 of the gaming system 100 (see FIG. 1). For simplicity, only certain modules used to carry out certain embodiments of the invention are illustrated in FIG. 6.

The controller 111 includes a processor 62 which is arranged to carry out the functions associated with triggering jackpots and awarding jackpot prizes. It will be apparent that the processor 62 implements a number of modules, namely a trigger module 622, configuration module 623, timer module 624, ticket management module 626, random number generator (RNG) 628, award module 632 and display controller module 634, based on program code stored in memory 64.

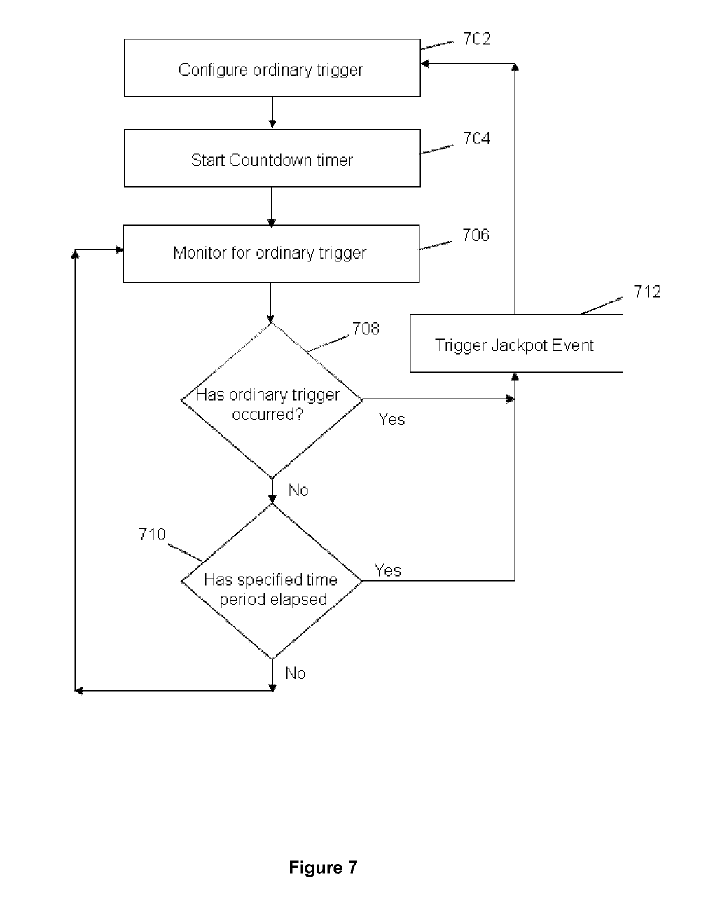

In more detail, and with reference to FIG. 7, the timer module 624 is programmed to effectively operate as a countdown timer which automatically counts down from a specified time after triggering of a previous jackpot event and triggers jackpot events during that time period in response to an ordinary trigger (e.g. mystery trigger) occurring. See blocks 702 to 708 and 712. If the specified time period has elapsed (i.e. the counter has reached time zero) without a trigger occurring, the timer module 624 sends an alert signal to the trigger module 622 causing the trigger module 622 to forcibly trigger the next jackpot event (as described in more detail in subsequent paragraphs). See blocks 710 to 712. Alternatively, the trigger module 622 may poll the timer module periodically to establish whether the predefined time period has elapsed.

The timer module 624 may be programmable such that the predefined time can be modified by a gaming operator, or automatically modified, depending on a set of timer rules 642 programmed into memory 64. In an embodiment, the timer rules 642 cause the predefined time to be adjusted dependent on a current time period. For example, during “off-peak” periods, the predefined time period may be shortened so as to provide players with an increased opportunity to be awarded a jackpot prize than would ordinarily be the case (e.g. where the triggering rules are ordinarily based on turnover).

In an embodiment, the timer rules 642 may dictate that the predefined time is slightly varied for each countdown so that players are unable to calculate the exact time at which the next jackpot event must be triggered. For example, the timer module 624 may be programmed to include a variance of plus or minus 20 minutes to the predefined time. The actual variance (within a particular tolerance) selected for each countdown event may be randomly determined utilising the RNG 628. In an alternative embodiment, the variance may follow a pathways selection technique whereby, for each subsequent countdown, a set variance will be applied according to a pre-programmed selection.

As described above, the trigger module 622 is operable to trigger the jackpot event in one of two ways. Firstly, the trigger module 622 may be “forced” to trigger the jackpot event in response to determining that the predefined time period has elapsed, as discussed above. Alternatively, the trigger module 622 may trigger the jackpot event in accordance with an “ordinary” triggering technique which dictates that the jackpot event be triggered before the predefined time period has elapsed.

In accordance with the embodiment illustrated herein, the ordinary jackpot event trigger is dependent, at least in part, on a predefined monetary turnover value associated with a gaming machine. More specifically, the event is ordinarily triggered when a predetermined number of “virtual tickets” have been allocated to participating gaming machines, as described in more detail below. It will readily be understood, however, that the jackpot event could ordinarily be triggered in any number of different ways. For example, the triggering technique could be based on a mystery-type technique whereby a jackpot event is triggered upon determining that a total value of contributions made by participating gaming machines toward a jackpot prize pool (from which the jackpot prize is awarded) has surpassed a randomly determined value. In an alternative embodiment, the jackpot prizes may be awarded in a feature game which is triggered using the Hyperlink™ trigger system, as described in published Australian patent No. 754689, the contents of which are incorporated herein by reference.

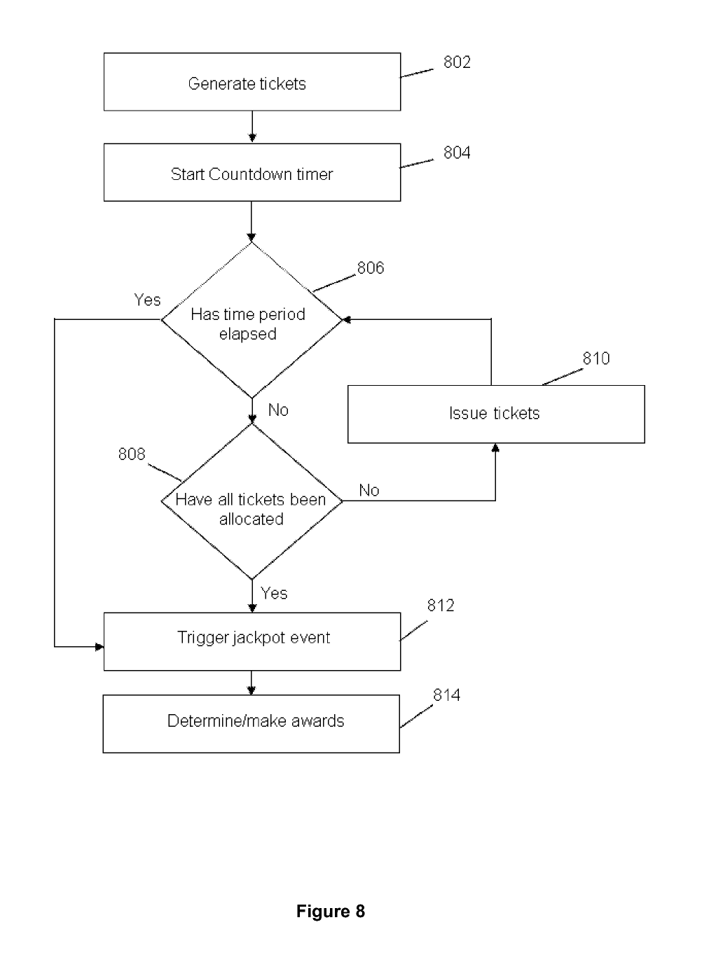

An example game play methodology is illustrated in FIG. 8.

In an initial block 802, a predefined number of virtual tickets are generated by the ticket management module 626, in accordance with a ticket issuing program 644 stored in the memory 64. The predefined number of tickets generated may, for example, correspond to the number of participating gaming machines. At block 804, the countdown timer 624 is started.

Blocks 806 and 808 involve determining whether both the predefined time period has elapsed and whether all tickets have been allocated. If a positive determination is made at either of blocks 806 or 808, the jackpot event is triggered (see explanation of block 812 below). If a negative determination is made, tickets are allocated to individual gaming machines as per the ticket allocation criteria (block 810). In the illustrated embodiment, ticket allocation is triggered by receipt at the ticket management module 626 of a communication from a gaming machine indicating that a gaming machine has reached a specific turnover threshold.

In the illustrated example, the jackpot event triggered at block 812 involves drawing a predefined number of virtual tickets from the same set of tickets generated at block 802. At block 814, the award module 632 awards prizes to players of gaming machines that have been allocated corresponding tickets. If the award module 632 determines that the drawn tickets do not correspond with any allocated tickets (e.g. where the jackpot prize event was forceably triggered before all generated tickets have been allocated), then no prizes are awarded and the process returns to block 802. In an embodiment, the predefined number of drawn tickets may depend on the number of gaming machines being played, the current jackpot prize pool value, the required return to player (RTP), or some other suitable parameter.

It will be appreciated that other awarding techniques may equally apply at block 814. For example, there may only be one major prize on offer and the probability of a gaming machine being awarded the major prize is dependent on the number of tickets allocated to that machine. Another example may involve randomly awarding prizes to machines that have been allocated tickets.

In accordance with the above embodiment, even during “off peak” times where the probability of ordinarily triggering a jackpot prize is reduced, players are still provided with an opportunity to win jackpot prizes by virtue of the forced time-based trigger.

While the above embodiment was described in relation to a gaming system which includes a plurality of gaming machines and a ticket management module in networked relationship to the gaming machines, it will be understood that other arrangements are possible. For example, the, or each, gaming machine may include a ticket management module or some aspects of the ticket allocation system so that game implementation including allocation of tickets and determining whether an allocated ticket corresponds to a winning outcome, occurs at the gaming machine.

In one embodiment, instead of allocating virtual tickets, actual physical tickets may be printed at the gaming machines.

In one embodiment, the physical tickets may themselves provide an indication to players as to whether an award has been received, for example in the form of scratch cards. In this way, drawing tickets to determine one or more winning tickets is not necessary.

It will be understood that in alternative embodiments, objects other than tickets may be allocated to the gaming machines. For example, instead of allocating tickets, the gaming machines may be awarded card hands. Each player's hand can then be played against the other in the jackpot event to win a prize.

It will be appreciated that the prize awarded by the award module 632 may be other than a monetary award. For example the prize may be a bonus award such as, for example, the issuing of free games, credits, or the like.

In the above described embodiments, the controller 111 was implemented by the jackpot controller 110 of the gaming system. However, it will readily be understood that the controller 111 could equally be implemented as a stand alone device, or incorporated into other suitable system modules. For example, if the FIG. 5 system architecture were utilised for game play, the controller 111 could be incorporated into one or more of the individual gaming machine player marketing modules 50.

The person skilled in the art will appreciate that the method of the embodiment could be implemented in program code. The program code could be supplied in a number of ways, for example on a computer readable medium, such as a disk or memory (for example, that could replace part of the memory 103) or as a data signal (for example, by downloading it from a server). The program code could be executed by more than one processing unit. For example, partly by the server module and partly by the client (and accordingly spread between a number of different locations).

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

It is to be understood that, if any prior art publication is referred to herein, such reference does not constitute an admission that the publication forms a part of the common general knowledge in the art, in Australia or any other country.

In the claims which follow and in the preceding description of embodiments of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments and/or aspects without departing from the spirit or scope of the invention as broadly described. For example, it will be apparent that certain features of the invention can be combined to form further embodiments. The present embodiments and aspects are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A method of awarding a jackpot, the method comprising:
initializing a timer to countdown a predefined period of time; and
monitoring a jackpot trigger that is configured to occur based on a monetary turnover value associated with a gaming device,
wherein if the jackpot trigger has occurred within the predefined period of time, resetting the timer; and
wherein if the jackpot trigger has not occurred within the predefined period of time, causing the jackpot trigger to occur irrespective of the monetary turnover value associated with the gaming machine and resetting the timer.

2. A method as claimed in claim 1, further comprising initiating a jackpot event in response to the jackpot trigger occurring.

3. A method as claimed in claim 2, further comprising varying the predefined time period for triggering subsequent jackpot events.

4. A method as claimed in claim 3, wherein an amount by which the predefined time is varied is not advertised to players of gaming devices participating in the jackpot event.

5. A method as claimed in claim 3, wherein the predefined time period is varied dependent, at least in part, on whether a current time period is a peak or off-peak time period.

6. A method as claimed in claim 5, further comprising making a determination as to whether the current period is a peak or non-peak time period based on a jackpot contribution rate for gaming devices participating in the jackpot event.

7. A method as claimed in claim 1, wherein a probability of the jackpot trigger occurring before the predefined time period has elapsed is dependent on either an amount or rate of contributions made by one or more of the participating gaming devices toward a prize pool from which a prize is awarded.

8. A method as claimed in claim 7, further comprising allocating tickets to the participating gaming devices in accordance with allocation criteria, such that for each of the participating gaming devices a probability of being awarded the prize is dependent on the number of tickets allocated thereto.

9. A method as claimed in claim 8, wherein the allocation criteria specifies a number or rate of tickets to allocate to individual participating gaming devices, based on contributions made towards the jackpot prize pool.

10. A method as claimed in claim 9, wherein the tickets are allocated to the participating gaming devices in a random fashion.

11. A method as claimed in claim 9, wherein the jackpot trigger is configured to occur when a predefined total number of tickets have been allocated or when a predefined jackpot prize pool amount has been reached.

12. A method as claimed in claim 9, wherein a probability of an individual participating gaming device being awarded the prize is dependent on the number of tickets allocated to that gaming device.

13. A method as claimed in claim 12, wherein the probability is further dependent on a total number of tickets allocated.

14. A controller for a gaming system, the controller comprising:
a configuration module operable to initialize a timer to countdown a predefined period of time and to monitor a jackpot trigger that is configured to occur based on a monetary turnover value associated with a gaming device; and
a trigger module arranged to, if the jackpot trigger has occurred within the predefined period of time, reset the timer, and, if the jackpot trigger has not occurred within the predefined period of time, cause the jackpot trigger to occur irrespective of the monetary turnover value associated with the gaming machine and reset the timer.

15. A controller as claimed in claim 14, wherein the predefined time period varies for subsequent jackpot triggers.

16. A controller as claimed in claim 15, wherein the predefined time period is varied dependent, at least in part, on whether a current time period is a peak or off-peak time period.

17. A controller as claimed in claim 16, wherein a determination is made as to whether the current period is a peak or non-peak time period based on a jackpot contribution rate for the participating gaming devices.

18. A controller as claimed in claim 14, wherein a probability of the jackpot trigger occurring before the predefined time period has elapsed is dependent either an amount or rate of contributions made by one or more of the gaming devices toward a prize pool from which a prize is awarded.

19. A controller as claimed in claim 18, further comprising a ticket allocating module arranged to allocate tickets to the participating gaming devices in accordance with an allocation criteria, such that for each of the participating gaming devices a probability of being awarded the prize is dependent on the number of tickets allocated thereto.

20. A controller as claimed in claim 19, wherein the ticket allocating module is arranged to process contributions made by participating gaming devices toward the prize pool and allocate tickets to those gaming devices based on their individual contributions.

21. A controller as claimed in claim 20, wherein the jackpot trigger is configured to occur when a predefined number of tickets have been allocated to participating gaming devices.

22. A gaming system comprising:
at least one gaming device arranged to participate in a jackpot event; and
a controller arranged to trigger a jackpot event in which a prize is eligible to be awarded, the controller comprising:
a configuration module operable to initialize a timer to countdown a predefined period of time and to monitor a jackpot trigger that is configured to occur based on a monetary turnover value associated with a gaming device; and
a trigger module arranged to, if the jackpot trigger has occurred within the predefined period of time, reset the timer, and, if the jackpot trigger has not occurred within the predefined period of time, cause the jackpot trigger to occur irrespective of the monetary turnover value associated with the gaming machine and reset the timer.

23. A gaming system as claimed in claim 22, wherein the controller is implemented by one or more of the at least one gaming devices.

24. A gaming device operable to communicate with other gaming devices over a communications network, the gaming device comprising:
a timer module operable to initialize a timer to countdown a predefined period of time and to provide notification that the predefined period of time has elapsed since triggering of a last jackpot event; and
a trigger module which, responsive to monitoring a jackpot trigger to determine if the jackpot trigger has occurred within a predefined period of time, is arranged to, if the jackpot trigger has occurred within the predefined period of time, reset the timer, and, if the jackpot trigger has not occurred within the predefined period time, cause the next jackpot event to be triggered and reset the timer.

25. A method of awarding a jackpot, the method comprising:
responsive to determining that a jackpot event has not been triggered within a predefined time period of a last jackpot event being triggered, triggering a next jackpot event; and
awarding a prize responsive to an award criterion being met in the next jackpot event. initializing a timer to countdown a predefined period of time; and
monitoring a jackpot trigger that is configured to occur based on a monetary turnover value associated with a gaming device,
wherein if the jackpot trigger has occurred within the predefined period of time, resetting the timer; and
wherein if the jackpot trigger has not occurred within the predefined period of time, causing the jackpot trigger to occur irrespective of the monetary turnover value associated with the gaming machine and resetting the timer.

26. A non-transitory computer readable storage medium comprising computer program code which when executed by a computing system implements a method of awarding a jackpot, the method comprising:
initializing a timer to countdown a predefined period of time; and
monitoring a jackpot trigger that is configured to occur based on a monetary turnover value associated with a gaming device,
wherein if the jackpot trigger has occurred within the predefined period of time, resetting the timer; and
wherein if the jackpot trigger has not occurred within the predefined period of time, causing the jackpot trigger to occur irrespective of the monetary turnover value associated with the gaming machine and resetting the timer.

27. A method of gaming comprising:
triggering a jackpot event based, at least in part, on a time since a last jackpot event was triggered, the time based on a timer initialized to count down a predefined period of time, wherein if the jackpot event has been triggered within the predefined period of time, resetting the timer and if the jackpot trigger has not occurred within the predefined period of time, triggering the jackpot event to trigger and resetting the timer.
